(19) United States
(12) Patent Application Publication
(10) Pub. No.: US 2025/0101884 A1
(43) Pub. Date: Mar. 27, 2025

(54) MULTI-MATERIAL FLOWPATH WALL FOR TURBINE ENGINE

(71) Applicant: RTX Corporation, Farmington, CT (US)

(72) Inventors: Lawrence A. Binek, Glastonbury, CT (US); Benjamin G. Gardell, Bristol, CT (US)

(21) Appl. No.: 18/371,868

(22) Filed: Sep. 22, 2023

(51) Int. Cl. F01D 25/24

(52) U.S. Cl. CPC F01D 25/24; F05D 2220/32; F05D 2230/31; F05D 2240/14; F05D 2300/603

(57) ABSTRACT

An assembly is provided for a turbine engine. This assembly includes a compressor rotor and a flowpath wall. The compressor rotor is rotatable about an axis. The compressor rotor includes a plurality of compressor blades arranged circumferentially around the axis. The flowpath wall forms an outer peripheral boundary of a flowpath in which the compressor blades are disposed. The flowpath wall includes a polymer shell and a metal liner bonded to the polymer shell. The polymer shell axially overlaps and circumscribes the metal liner. The metal liner axially overlaps and circumscribes the compressor blades.

### BACKGROUND OF THE DISCLOSURE

### 1. Technical Field

This disclosure relates generally to a turbine engine and, more particularly, to a flowpath wall for the turbine engine.

### 2. Background Information

A gas turbine engine includes various flowpath walls such as shrouds, liners, casings and the like forming peripheral boundaries of a flowpath within the gas turbine engine. Various types and configurations of flowpath walls are known in the art. While these known flowpath walls have various benefits, there is still room in the art for improvement.

### SUMMARY OF THE DISCLOSURE

According to an aspect of the present disclosure, an assembly is provided for a turbine engine. This assembly includes a compressor rotor and a flowpath wall. The compressor rotor is rotatable about an axis. The compressor rotor includes a plurality of compressor blades arranged circumferentially around the axis. The flowpath wall forms an outer peripheral boundary of a flowpath in which the compressor blades are disposed. The flowpath wall includes a polymer shell and a metal liner bonded to the polymer shell. The polymer shell axially overlaps and circumscribes the metal liner. The metal liner axially overlaps and circumscribes the compressor blades.

According to another aspect of the present disclosure, another assembly is provided for a turbine engine. This assembly includes a flowpath wall. The flowpath wall includes a sidewall, a flange, a polymer shell and a metal liner. The sidewall extends circumferentially around an axis. The sidewall extends axially along the axis from an upstream end of the flowpath wall to a downstream end of the flowpath wall. The sidewall is formed by the polymer shell and the metal liner. The flange is disposed at the downstream end of the flowpath wall. The flange projects radially out from the sidewall. The flange extends circumferentially around the axis. The flange is formed by at least the metal liner. The polymer shell extends axially along and circumscribes the metal liner. The metal liner is bonded to the polymer shell. The metal liner at least partially forms an outer peripheral boundary of a flowpath axially along and radially within the flowpath wall.

According to still another aspect of the present disclosure, a method of manufacture is provided during which a tubular flowpath wall is formed that includes a sidewall, a flange, a shell and a liner. The sidewall extends axially along an axis from an upstream end of the tubular flowpath wall to a downstream end of the tubular flowpath wall. The sidewall is formed by the shell and the liner. The flange is disposed at the downstream end of the tubular flowpath wall. The flange projects radially out from the sidewall. The flange is formed by at least the liner. The shell extends axially along and circumscribes the liner. The liner at least partially forms an outer peripheral boundary of a flowpath axially along and radially within the tubular flowpath wall. The forming of the tubular flowpath wall includes: additively manufacturing the shell from a polymeric material; and additively manufacturing the liner onto the shell from a metal material.

The additively manufacturing of the shell may include building the shell using a material extrusion process. In addition or alternatively, the additively manufacturing of the liner may include building the liner onto the shell using a cold spray process.

The compressor blades may include a first compressor blade. The metal liner may be radially adjacent a tip of the first compressor blade.

The compressor blades may include a first compressor blade. A clearance gap may be formed by and extend between the metal liner and a tip of the first compressor blade.

The metal liner may extend partially axially along the flowpath wall.

The polymer shell may include a first shell section and a second shell section. The flowpath wall may include a first wall section and a second wall section axially adjacent the first wall section. The first wall section may be configured as and/or only include the first shell section. The second shell section may include the second shell section and at least a portion of the metal liner.

The first wall section may be upstream of the second wall section along the flowpath.

The metal liner may be disposed in a recess of the polymer shell such that an inner surface of the metal liner is flush with or recessed from an inner surface of the polymer shell.

The metal liner may extend axially along an entire length of the polymer shell.

The flowpath wall may include a tubular sidewall and an annular flange. The polymer shell and the metal liner may collectively form the tubular sidewall. At least the metal liner may form the annular flange.

The polymer shell and the metal liner may collectively form the annular flange.

An axial thickness of a portion of the metal liner forming the annular flange may be greater than an axial thickness of a portion of the polymer shell forming the annular flange.

The flowpath wall may be a first flowpath wall and the outer peripheral boundary of the flowpath may be a first outer peripheral boundary of the flowpath. The assembly may also include a second flowpath wall forming a second outer peripheral boundary of the flowpath. The second flowpath wall may be mechanically fastened to the first flowpath wall at a bolted flange joint.

The second flowpath wall may be formed from metal. The metal liner may axially engage the second flowpath wall.

The outer peripheral boundary of the flowpath formed by the flowpath wall may have a convex sectional geometry extending axially along the axis between a first end of the flowpath wall and a second end of the flowpath wall.

A thickness of the metal liner at a location axially aligned with the compressor rotor may be equal to or greater than a thickness of the polymer shell at the location.

A thickness of the metal liner at a location axially aligned with the compressor rotor may be less than a thickness of the polymer shell at the location.

The assembly may also include a compressor section, a combustor section and a turbine section. The compressor section may include the compressor rotor. The flowpath may extend sequentially through the compressor section, the combustion section and the turbine section from an inlet into the flowpath to an exhaust from the flowpath.

The flowpath wall may form the inlet into the flowpath.

The present disclosure may include any one or more of the individual features disclosed above and/or below alone or in any combination thereof.

The foregoing features and the operation of the invention will become more apparent in light of the following description and the accompanying drawings.

### BRIEF DESCRIPTION OF THE DRAWINGS

FIG. 1 is a side sectional schematic illustration of a gas turbine engine.

FIG. 2 is a side sectional illustration of a flowpath wall.

FIG. 3 is a partial side sectional illustration of the flowpath wall housing a compressor rotor.

FIGS. 4A and 4B are partial side sectional illustrations of the flowpath wall with various interfaces between a polymer shell and a metal liner.

FIG. 5 is a partial side sectional illustration of the flowpath wall with a full length metal liner.

FIGS. 6A-C are partial side sectional illustrations of the flowpath wall with various radial thicknesses between the polymer shell and the metal liner.

FIGS. 7A-C are partial side sectional illustrations of the flowpath wall with various axial thicknesses between the polymer shell and the metal liner.

FIGS. 8A-C are side sectional schematic illustrations of the flowpath wall during various stages of manufacture.

### DETAILED DESCRIPTION

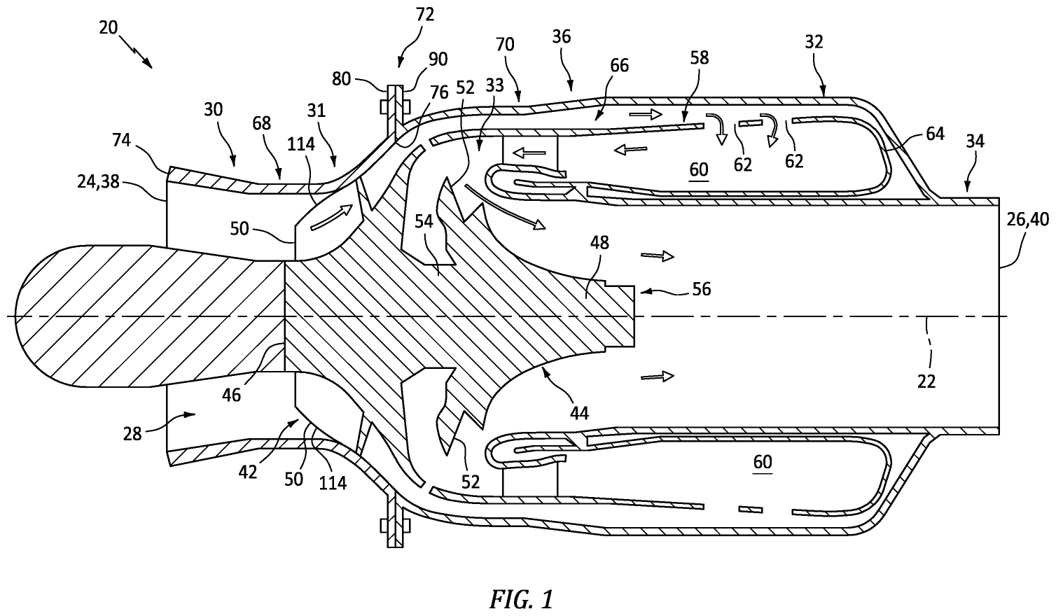

FIG. 1 illustrates a gas turbine engine 20 for a vehicle. This vehicle may be an airplane, a drone (e.g., an unmanned aerial vehicle (UAV)) or any other manned or unmanned aircraft or self-propelled projectile. The turbine engine 20 may be configured as, or otherwise included as part of, a propulsion system for the vehicle. The turbine engine 20 may also or alternatively be configured as, or otherwise included as part of, an electrical power system (e.g., an auxiliary power unit (APU)) for the vehicle.

The turbine engine 20 extends axially along a centerline axis 22 from a forward, upstream airflow inlet 24 into the turbine engine 20 to an aft, downstream combustion products exhaust 26 from the turbine engine 20. The centerline axis 22 may be an axial centerline and/or a rotational axis of the turbine engine 20 and/or one or more components of the turbine engine 20.

The turbine engine 20 includes a core flowpath 28, an inlet section 30, a compressor section 31, a (e.g., reverse flow) combustor section 32, a turbine section 33 and an exhaust section 34. At least (or only) the compressor section 31, the combustor section 32 and the turbine section 33 may form a core of the turbine engine 20. The turbine engine 20 also includes a stationary structure 36 housing and/or forming one or more (or all) of the engine sections 30-34.

The core flowpath 28 extends longitudinally within the turbine engine 20 and its engine core from an airflow inlet 38 into the core flowpath 28 to a combustion products exhaust 40 from the core flowpath 28. More particularly, the core flowpath 28 of FIG. 1 extends sequentially longitudinally through the inlet section 30, the compressor section 31, the combustor section 32, the turbine section 33 and the exhaust section 34 from the core inlet 38 to the core exhaust 40. The core inlet 38 may form the engine inlet 24 into the turbine engine 20. The core exhaust 40 may form the engine exhaust 26 from the turbine engine 20.

The compressor section 31 includes a bladed compressor rotor 42. The turbine section 33 includes a bladed turbine rotor 44. Each of these engine rotors 42, 44 includes a rotor base 46, 48 (e.g., a hub or a disk) and a plurality of rotor blades 50, 52 arranged circumferentially around and connected to the rotor base 46, 48. The rotor blades 50, 52, for example, may be formed integral with or mechanically fastened, welded, brazed and/or otherwise attached to the respective rotor base 46, 48.

The compressor rotor 42 may be configured as a radial flow compressor rotor (e.g., an axial inflow-radial outflow compressor rotor), and the compressor section 31 may be configured as a radial flow compressor section. The turbine rotor 44 may be configured as a radial flow turbine rotor (e.g., a radial inflow-axial outflow turbine rotor), and the turbine section 33 may be configured as a radial flow turbine section. The compressor rotor 42 is connected to the turbine rotor 44 through an engine shaft 54. At least (or only) the compressor rotor 42, the turbine rotor 44 and the engine shaft 54 may collectively form an engine rotating assembly 56 (e.g., a spool) of the turbine engine 20. This rotating assembly 56 and its engine shaft 54 are rotatably supported by the stationary structure 36 through one or more bearings (not shown for ease of illustration). With this arrangement the rotating assembly 56 and each of its members 42, 44 and 54 may rotate about the centerline axis 22.

The combustor section 32 includes a combustor 58 (e.g., an annular combustor) with an internal combustion chamber 60 (e.g., an annular combustion chamber). The combustor 58 of FIG. 1 is configured as a reverse flow combustor. Inlets ports 62/flow tubes into the combustion chamber 60, for example, may be arranged at (e.g., on, adjacent or proximate) and/or towards an aft bulkhead wall 64 of the combustor 58. An outlet from the combustor 58 may be arranged axially aft of an inlet to the turbine section 33. The combustor 58 may also be arranged radially outboard of and/or axially overlap at least a (e.g., aft) portion of the turbine section 33. With this arrangement, the core flowpath 28 of FIG. 1 reverses direction (e.g., from a forward-to-aft direction to an aft-to-forward direction) a first time as the core flowpath 28 extends from a diffuser plenum 66 surrounding the combustor 58 into the combustion chamber 60. The core flowpath 28 of FIG. 1 then reverses direction (e.g., from the aft-to-forward direction to the forward-to-aft direction) a second time as the core flowpath 28 extends from the combustion chamber 60 into the turbine section 33.

During turbine engine operation, air enters the turbine engine 20 through the inlet section 30 and its core inlet 38. The inlet section 30 directs the air from the core inlet 38 into the core flowpath 28 and the compressor section 31. The air entering the core flowpath 28 may be referred to as “core air”. This core air is compressed by the compressor rotor 42. The compressed core air is directed through a diffuser and its diffuser plenum 66 into the combustion chamber 60. Fuel is injected and mixed with the compressed core air to provide a fuel-air mixture. This fuel-air mixture is ignited within the combustion chamber 60, and combustion products thereof flow through the turbine section 33 and cause the turbine rotor 44 to rotate. The rotation of the turbine rotor 44 drives rotation of the compressor rotor 42 and, thus, compression of the air received from the core inlet 38.

The stationary structure 36 includes a plurality of (e.g., tubular) flowpath walls 68 and 70 arranged longitudinally along the core flowpath 28. Each of these flowpath walls 68, 70 is configured to form a respective outer peripheral boundary of the core flowpath 28 within the turbine engine 20. The upstream flowpath wall 68 of FIG. 1, for example, forms the outer peripheral boundary of the core flowpath 28 from the core inlet 38, through the inlet section 30 and into the compressor section 31. The downstream flowpath wall 70 of FIG. 1 forms the outer peripheral boundary of the core flowpath 28 downstream of the upstream flowpath wall 68; e.g., out of the compressor section 31, along the diffuser plenum 66 surrounding the combustor 58, etc. The downstream flowpath wall 70 is mechanically fastened or otherwise attached to the upstream flowpath wall 68 at an inter-wall coupling 72; e.g., a bolted flange joint. This inter-wall coupling 72 may be axially aligned with (e.g., axially overlap) the compressor rotor 42 and its compressor blades 50. The inter-wall coupling 72, however, may alternatively be downstream of the compressor rotor 42 and its compressor blades 50 along the core flowpath 28, or otherwise located.

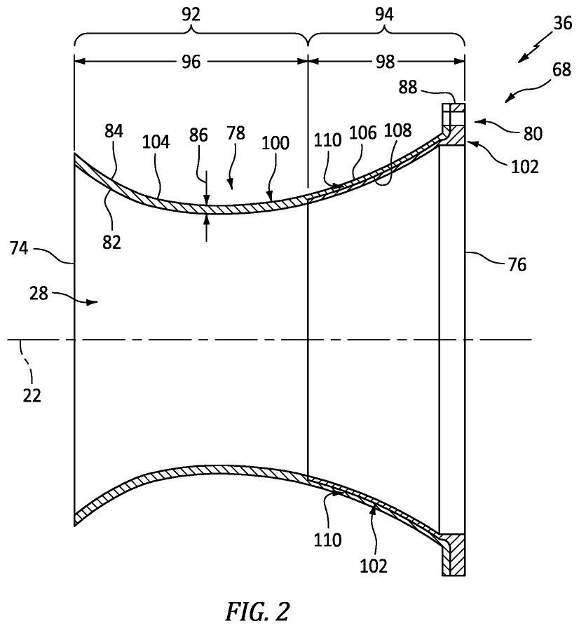

Referring to FIG. 2, the upstream flowpath wall 68 extends axially along the centerline axis 22 (and longitudinally along the core flowpath 28) from a forward, upstream end 74 of the upstream flowpath wall 68 to an aft, downstream end 76 of the upstream flowpath wall 68. The upstream end 74 of the upstream flowpath wall 68 may also be a forward, upstream end of the turbine engine 20 of FIG. 1 and its inlet section 30. The upstream flowpath wall 68 of FIG. 2 includes an upstream flowpath wall sidewall 78 (e.g., a tubular sidewall) and an upstream flowpath wall flange 80 (e.g., an annular flange or another type of mount).

The sidewall 78 extends axially along the centerline axis 22 (and longitudinally along the core flowpath 28) from the upstream end 74 of the upstream flowpath wall 68 to the downstream end 76 of the upstream flowpath wall 68. The sidewall 78 extends circumferentially about (e.g., completely around) the centerline axis 22. The sidewall 78 of FIG. 2 may thereby have a full-hoop (e.g., tubular) geometry. The sidewall 78 extends radially from an inner side 82 of the upstream flowpath wall 68 and its sidewall 78 to an outer side 84 of the sidewall 78. With this arrangement, the inner side 82 (e.g., completely) forms the outer peripheral boundary of the core flowpath 28 axially and/or longitudinally along the upstream flowpath wall 68.

The sidewall 78 of FIG. 2 has a thickness 86 measured between the inner side 82 and the outer side 84. This thickness 86 may be substantially or completely uniform (e.g., constant) as the sidewall 78 extends from (or about) the upstream end 74 to (or about) the downstream end 76. However, it is contemplated the thickness 86 may be non-uniform in other embodiments. The inner side 82 and, thus, the outer peripheral boundary of the core flowpath 28 along the upstream flowpath wall 68 may have convex sectional geometry when viewed, for example, in a reference plane parallel with (e.g., including) the centerline axis 22; e.g., a plane of FIG. 2. The sidewall 78 and its inner side 82 of FIG. 2, for example, is (e.g., continuously) curved from (or about) the upstream end 74 to (or about) the downstream end 76. In other embodiments, however, the sidewall 78 and its inner side 82 may also or alternatively include one or more non-curved sections (e.g., straight-line sections) and/or one or more (e.g., curved) concave sections depending on the specific turbine engine architecture.

The wall flange 80 is connected to the sidewall 78 at the downstream end 76. The wall flange 80 of FIG. 2, for example, extends axially along the centerline axis 22 and the sidewall 78 to the downstream end 76. The wall flange 80 projects radially (in a direction away from the centerline axis 22) out from sidewall 78 and its outer side 84 to an outer distal end 88 of the wall flange 80. The wall flange 80 extends circumferentially about (e.g., completely around) the centerline axis 22. The wall flange 80 of FIG. 2 may thereby have a full-hoop (e.g., tubular) geometry which circumscribes the sidewall 78. With this arrangement, the wall flange 80 is configured for mounting the upstream flowpath wall 68. For example, referring to FIG. 1, the wall flange 80 of the upstream flowpath wall 68 axially engages (e.g., is abutted against, contacts, etc.) an annular flange 90 of the downstream flowpath wall 70. These flanges 80 and 90 are bolted together by a plurality of fasteners thereby forming the inter-wall coupling 72 connecting the upstream flowpath wall 68 to the downstream flowpath wall 70. Here, the upstream flowpath wall 68 may be cantilevered from the downstream flowpath wall 70. The upstream flowpath wall 68 of FIG. 1, for example, is substantially unsupported at its upstream end 74. Moreover, the upstream flowpath wall 68 of FIG. 1 is also configured as a non-load bearing portion of the stationary structure 36. Structural loads, for example, are not transmitted through the upstream flowpath wall 68 between other components of the turbine engine 20. The present disclosure, however, is not limited to such an exemplary cantilevered and/or non-load bearing arrangement.

Referring to FIG. 2, the upstream flowpath wall 68 is configured with an upstream wall section 92 and a downstream wall section 94 The upstream wall section 92 extends axially along the centerline axis 22 (longitudinally along the core flowpath 28) from the upstream end 74 to the downstream wall section 94. The upstream wall section 92 of FIG. 2 thereby forms an upstream portion of the sidewall 78. The downstream wall section 94 extends axially along the centerline axis 22 (longitudinally along the core flowpath 28) from the downstream end 76 to the upstream wall section 92. The downstream wall section 94 of FIG. 2 thereby forms (and includes) a downstream portion of the sidewall 78 and the wall flange 80. An axial length 96 of the upstream wall section 92 of FIG. 2 is greater than an axial length 98 of the downstream wall section 94. The axial length 96 of the upstream wall section 92, however, may alternatively be equal to or less than the axial length 98 of the downstream wall section 94 in other embodiments.

The upstream flowpath wall 68 is configured as a composite structure. The upstream flowpath wall 68 of FIG. 2, for example, is configured as a metal reinforced polymer flowpath wall. More particularly, the upstream flowpath wall 68 of FIG. 2 includes a polymer shell 100 and a metal liner 102.

The polymer shell 100 of FIG. 2 extends axially along the centerline axis 22 (longitudinally along the core flowpath 28) from the upstream end 74 to and/or at least partially along the wall flange 80 at the downstream end 76. The polymer shell 100 may thereby extend along substantially (e.g., between 95% to 99% of) an entire axial length of the upstream flowpath wall 68 between the upstream end 74 and the downstream end 76. The polymer shell 100 of FIG. 2 is configured with an upstream shell section 104 and a downstream shell section 106.

The upstream shell section 104 projects axially along the centerline axis 22 (longitudinally along the core flowpath 28) out from the upstream end 74 to the downstream shell section 106 and/or the downstream wall section 94. The upstream shell section 104 extends radially between and to the inner side 82 and the outer side 84. The upstream shell section 104 extends circumferentially about (e.g., completely around) the centerline axis 22 and the core flowpath 28.

The downstream shell section 106 projects axially along the centerline axis 22 (longitudinally along the core flowpath 28) out from the upstream shell section 104 and/or the upstream wall section 92 to and/or at least partially along the wall flange 80. A wall portion of the downstream shell section 106 extends radially between and to an inner side 108 of the downstream shell section 106 and the outer side 84, where the inner side 108 of the downstream shell section 106 is recessed from (e.g., spaced radially outwards from) the inner side 82 of the upstream flowpath wall 68. A flange portion of the downstream shell section 106 projects radially out from the wall portion of the downstream shell section 106 to the outer distal end 88 of the wall flange 80. The downstream shell section 106 extends circumferentially about (e.g., completely around) the centerline axis 22 and the core flowpath 28. With this arrangement, an annular recess 110 projects radially into the polymer shell 100 from the inner side 82 of the upstream flowpath wall 68 to the inner side 108 of the downstream shell section 106. The recess 110 extends longitudinally into the downstream shell section 106 to the upstream shell section 104.

The metal liner 102 is bonded and/or otherwise attached to the polymer shell 100. The metal liner 102 of FIG. 2 is also mated with and fills the recess 110. A wall portion of the metal liner 102 of FIG. 2, for example, projects radially inward from the downstream shell section 106 and its inner side 108 to the inner side 82 of the upstream flowpath wall 68. This wall portion of the metal liner 102 also extends axially along the centerline axis 22 (longitudinally along the core flowpath 28) from the downstream end 76 to the upstream shell section 104. A flange portion of the metal liner 102 is abutted axially against the flange portion of the downstream shell section 106. This flange portion of the metal liner 102 also projects radially out from the wall portion of the metal liner 102 to the outer distal end 88 of the wall flange 80. The metal liner 102 extends circumferentially about (e.g., completely around) the centerline axis 22 and the core flowpath 28. Here, the polymer shell 100 and its downstream shell section 106 are radially outboard of the wall portion of the metal liner 102. The polymer shell 100 and its downstream shell section 106 also extend axially along (e.g., axially overlap) and extend circumferentially about (e.g., circumscribe) the wall portion of the metal liner 102.

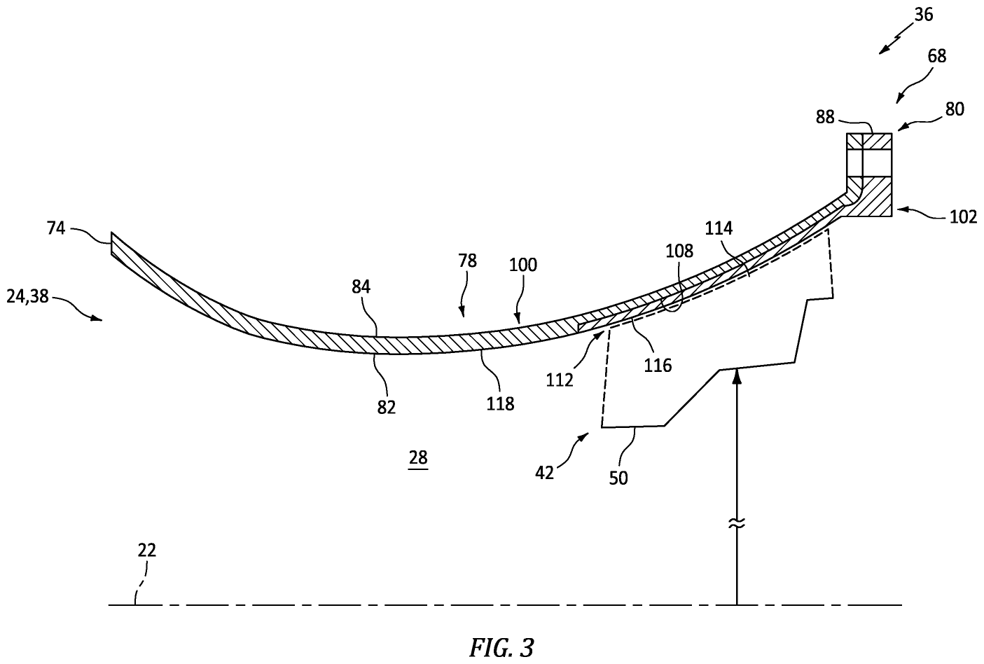

With the foregoing arrangement, the upstream wall section 92 may be (e.g., completely) formed by the polymer shell 100 and its upstream shell section 104. The downstream wall section 94, on the other hand, may be collectively formed by (a) the polymer shell 100 and its downstream shell section 106 and (b) the metal liner 102. More particularly, a downstream portion of the sidewall 78 is collectively formed by the wall portion of the downstream shell section 106 and the wall portion of the metal liner 102. The wall flange 80 is collectively formed by the flange portion of the downstream shell section 106 and the flange portion of the metal liner 102. The metal liner 102 may thereby structurally reinforce the polymer shell 100 to provide a light-weight, structurally robust flowpath wall structure. Moreover, referring to FIG. 3, the metal liner 102 is disposed radial outboard of and adjacent, axially overlaps and circumscribes the compressor rotor 42 and its compressor blades 50. By lining at least (or only) this portion of the upstream flowpath wall 68 that houses the compressor rotor 42 with the metal liner 102, a relatively small clearance gap 112 may be provided between tips 114 of the compressor blades 50 and the upstream flowpath wall 68 and its metal liner 102.

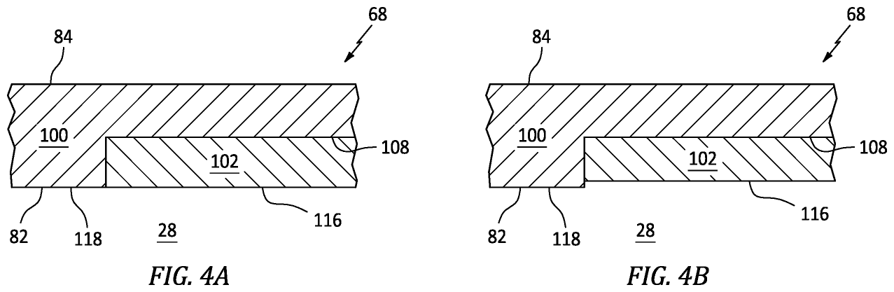

In some embodiments, referring to FIG. 4A, an inner surface 116 of the metal liner 102 may be flush with an inner surface 118 of the polymer shell 100 at an axial and/or longitudinal interface between the metal liner 102 and the polymer shell 100. In other embodiments, referring to FIG. 4B, the liner inner surface 116 may be recessed (e.g., slightly) outward from the shell inner surface 118 to provide a water-fall effect from the polymer shell 100 to the metal liner 102.

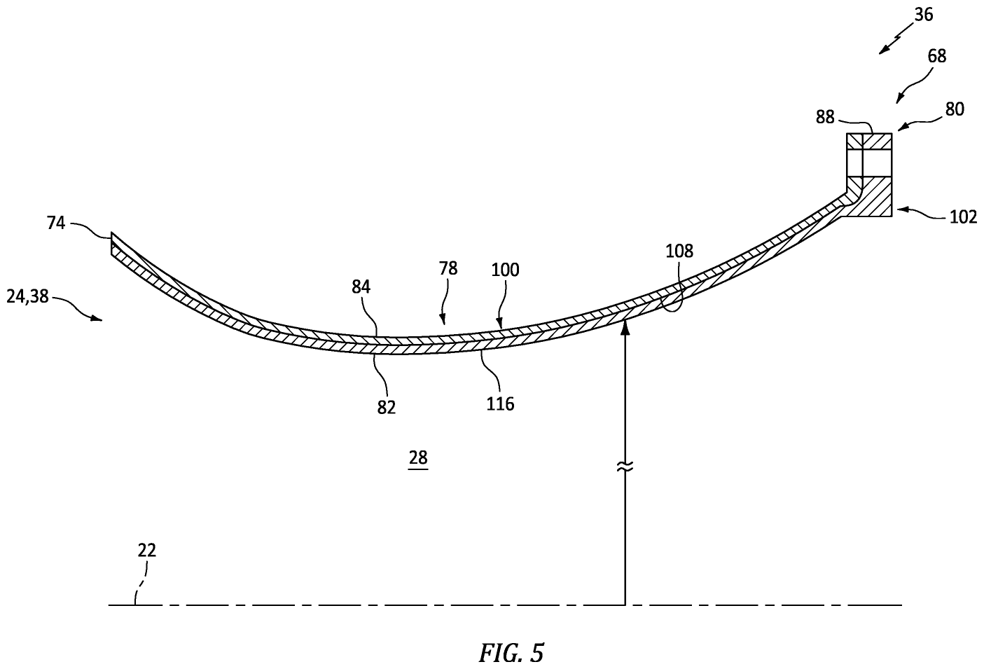

In some embodiments, referring to FIGS. 2 and 3, the metal liner 102 may extend partially axially and/or longitudinally along the upstream flowpath wall 68 and its polymer shell 100. In other embodiments, referring to FIG. 5, the metal liner 102 may extend axially and/or longitudinally along the entire length of the upstream flowpath wall 68 and its polymer shell 100 between the upstream end 74 and the downstream end 76.

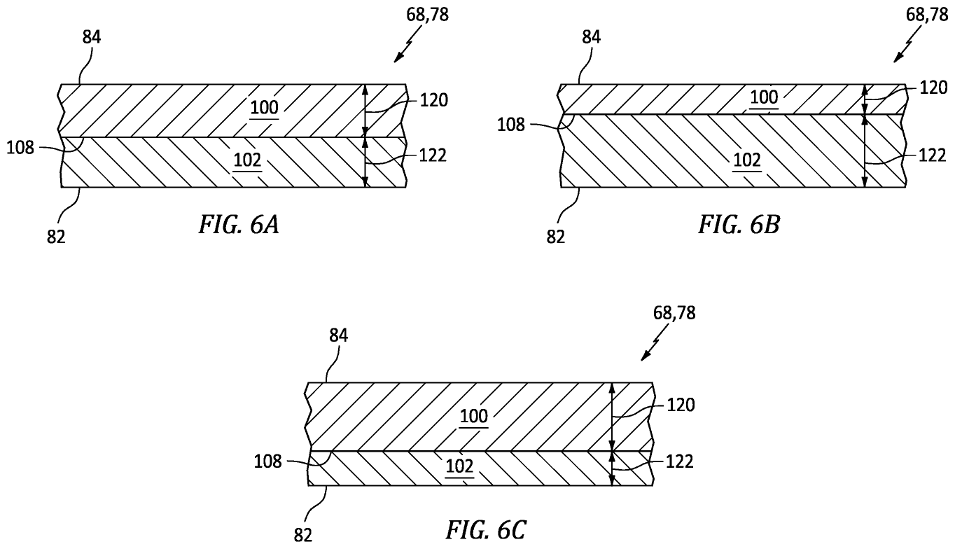

Referring to FIGS. 6A-C, the polymer shell 100 has a (e.g., generally radial) thickness 120 and the metal liner 102 has a (e.g., generally radial) thickness 122 at a location axially and/or longitudinally along the sidewall 78 and axially and/or longitudinally aligned with (e.g., overlapping) the compressor rotor 42 and its compressor blades 50. In some embodiments, referring to FIG. 6A, the shell thickness 120 may be equal to the liner thickness 122. In other embodiments, referring to FIG. 6B, the shell thickness 120 may be less than the liner thickness 122. In still other embodiments, referring to FIG. 6C, the shell thickness 120 may be greater than the liner thickness 122; however, the liner thickness 122 may still be large enough to stiffen and structurally support the polymer liner 100.

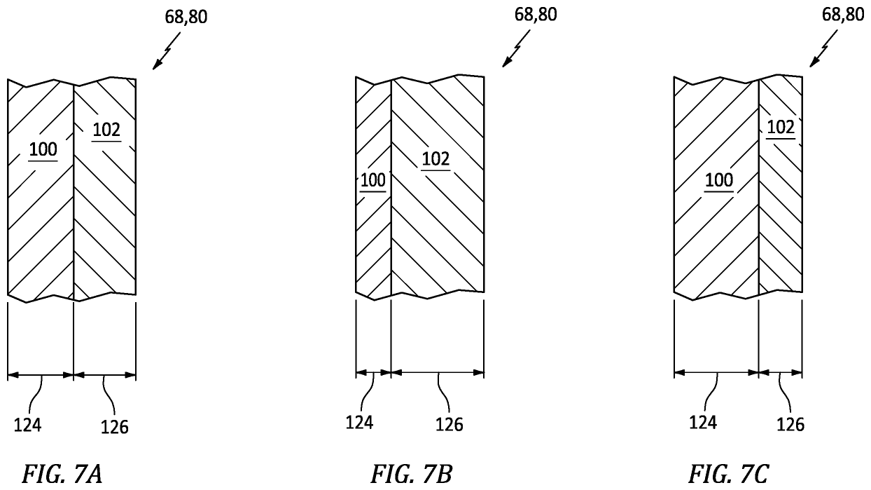

Referring to FIGS. 7A-C, the polymer shell 100 has a (e.g., generally axial) thickness 124 and the metal liner 102 has a (e.g., generally axial) thickness 126 at a location radially along the wall flange 80. In some embodiments, referring to FIG. 7A, the shell thickness 124 may be equal to the liner thickness 126. In other embodiments, referring to FIG. 7B, the shell thickness 124 may be less than the liner thickness 126. In still other embodiments, referring to FIG. 7C, the shell thickness 124 may be greater than the liner thickness 126.

The polymer shell 100 may be constructed from or otherwise include a polymer material such as a polyetherimide (e.g., Ultem®). Examples of other suitable polymer materials may include, but are not limited to, polysulfone, polyetheretherketone, polyetherketoneketone, polyphthalamide, polyphenyl sulfone, nylon or other filler materials. The metal liner 102 may be constructed from or otherwise include a metal material such as aluminum (Al) or an aluminum alloy, titanium (Ti) or a titanium alloy, or steel. The downstream flowpath wall 70 of FIG. 1 may also be constructed from or otherwise include a metal material such as aluminum or an aluminum alloy, titanium or a titanium alloy, or steel. The present disclosure, however, is not limited to the foregoing exemplary materials.

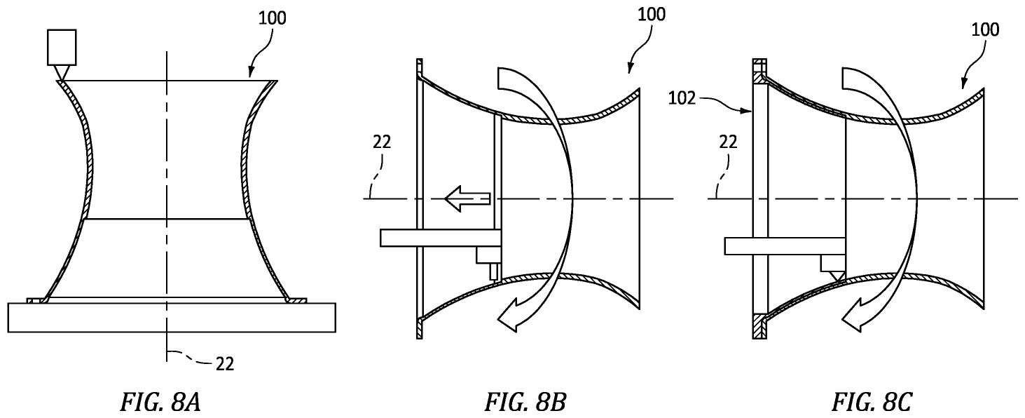

FIGS. 8A-C illustrate various steps in a method for manufacturing a composite (e.g., multi-material) flowpath wall such as the upstream flowpath wall 68 described above. During this manufacturing method, referring to FIG. 8A, the polymer shell 100 may be additively manufactured using an additive manufacturing process such as a polymer material extrusion (MEX) process. The polymer shell 100, for example, may be built up layer-by-layer onto a build surface using a polymer material extrusion (MEX) system. Of course, the polymer shell 100 may alternatively be built up layer-by-layer onto the build surface using various other additive manufacturing processes such as, but not limited to, a polymer powder bed fusion (PBF) process (also referred to as “SLS”), a vat photopolymerization (VPP) process, a material jetting (MJT) process, or a polymer direct energy deposition (DED) process. Referring to FIG. 8B, the metal liner 102 may be additively manufactured onto the polymer shell 100 using another additive manufacturing process such as a cold spray process. The polymer shell 100, for example, may be fixtured and turned about the centerline axis 22 while a cold spray direct energy deposition system builds up the metal material onto the polymer shell 100 to form the metal liner 102 (see FIG. 8C). Referring to FIG. 8C, at least a portion of the upstream flowpath wall 68 and its metal liner 102 (and/or optionally its polymer shell 100) may then be machined (e.g., milled, etc.) to provide the liner inner surface 116 with a specified surface finish and dimension to facilitate the relatively small clearance gap 112 of FIG. 3.

The turbine engine 20 of FIG. 1 is described above as a single spool, radial-flow turbojet turbine engine for ease of description. The present disclosure, however, is not limited to such an exemplary gas turbine engine. The turbine engine 20, for example, may alternatively be configured as an axial flow gas turbine engine. The turbine engine 20 may be configured as a direct drive gas turbine engine. The turbine engine 20 may alternatively include a geartrain that connects one or more rotors together such that the rotors rotate at different speeds. The turbine engine 20 may be configured with a single spool (e.g., see FIG. 1), two spools, or with more than two spools. The turbine engine 20 may be configured as a turbofan engine, a turbojet engine, a turboprop engine, a turboshaft engine, a propfan engine, a pusher fan engine or any other type of turbine engine. In addition, while the turbine engine 20 is described above with an exemplary reverse flow annular combustor, the turbine engine 20 may also or alternatively include any other type/configuration of annular, tubular (e.g., CAN), axial flow and/or reverse flow combustor. The present disclosure therefore is not limited to any particular types or configurations of gas turbine engines.

While various embodiments of the present disclosure have been described, it will be apparent to those of ordinary skill in the art that many more embodiments and implementations are possible within the scope of the disclosure. For example, the present disclosure as described herein includes several aspects and embodiments that include particular features. Although these features may be described individually, it is within the scope of the present disclosure that some or all of these features may be combined with any one of the aspects and remain within the scope of the disclosure. Accordingly, the present disclosure is not to be restricted except in light of the attached claims and their equivalents.

What is claimed is:

1. An assembly for a turbine engine, comprising:
a compressor rotor rotatable about an axis, the compressor rotor including a plurality of compressor blades arranged circumferentially around the axis;
a flowpath wall forming an outer peripheral boundary of a flowpath in which the plurality of compressor blades are disposed, the flowpath wall including a polymer shell and a metal liner bonded to the polymer shell, the polymer shell axially overlapping and circumscribing the metal liner, and the metal liner axially overlapping and circumscribing the plurality of compressor blades.

2. The assembly of claim 1, wherein
the plurality of compressor blades comprise a first compressor blade; and
the metal liner is radially adjacent a tip of the first compressor blade.

3. The assembly of claim 1, wherein
the plurality of compressor blades comprise a first compressor blade; and
a clearance gap is formed by and extends between the metal liner and a tip of the first compressor blade.

4. The assembly of claim 1, wherein the metal liner extends partially axially along the flowpath wall.

5. The assembly of claim 1, wherein
the polymer shell includes a first shell section and a second shell section; and
the flowpath wall includes a first wall section and a second wall section axially adjacent the first wall section, the first wall section consists of the first shell section, and the second shell section includes the second shell section and at least a portion of the metal liner.

6. The assembly of claim 5, wherein the first wall section is upstream of the second wall section along the flowpath.

7. The assembly of claim 1, wherein the metal liner is disposed in a recess of the polymer shell such that an inner surface of the metal liner is flush with or recessed from an inner surface of the polymer shell.

8. The assembly of claim 1, wherein the metal liner extends axially along an entire length of the polymer shell.

9. The assembly of claim 1, wherein
the flowpath wall includes a tubular sidewall and an annular flange;
the polymer shell and the metal liner collectively form the tubular sidewall; and
at least the metal liner forms the annular flange.

10. The assembly of claim 9, wherein the polymer shell and the metal liner collectively form the annular flange.

11. The assembly of claim 10, wherein an axial thickness of a portion of the metal liner forming the annular flange is greater than an axial thickness of a portion of the polymer shell forming the annular flange.

12. The assembly of claim 1, wherein the flowpath wall is a first flowpath wall and the outer peripheral boundary of the flowpath is a first outer peripheral boundary of the flowpath, and further comprising:
a second flowpath wall forming a second outer peripheral boundary of the flowpath;
the second flowpath wall mechanically fastened to the first flowpath wall at a bolted flange joint.

13. The assembly of claim 12, wherein
the second flowpath wall is formed from metal; and
the metal liner axially engages the second flowpath wall.

14. The assembly of claim 1, wherein the outer peripheral boundary of the flowpath formed by the flowpath wall has a convex sectional geometry extending axially along the axis between a first end of the flowpath wall and a second end of the flowpath wall.

15. The assembly of claim 1, wherein a thickness of the metal liner at a location axially aligned with the compressor rotor is equal to or greater than a thickness of the polymer shell at the location.

16. The assembly of claim 1, further comprising:
a compressor section comprising the compressor rotor;
a combustor section; and
a turbine section;
the flowpath extending sequentially through the compressor section, the combustion section and the turbine section from an inlet into the flowpath to an exhaust from the flowpath.

17. The assembly of claim 16, wherein the flowpath wall forms the inlet into the flowpath.

18. An apparatus for a turbine engine, comprising:
a flowpath wall including a sidewall, a flange, a polymer shell and a metal liner;
the sidewall extending circumferentially around an axis, the sidewall extending axially along the axis from an upstream end of the flowpath wall to a downstream end of the flowpath wall, and the sidewall formed by the polymer shell and the metal liner;
the flange disposed at the downstream end of the flowpath wall, the flange projecting radially out from the sidewall, the flange extending circumferentially around the axis, and the flange formed by at least the metal liner;
the polymer shell extending axially along and circumscribing the metal liner; and
the metal liner bonded to the polymer shell, and the metal liner at least partially forming an outer peripheral boundary of a flowpath axially along and radially within the flowpath wall.

19. A method of manufacture, comprising:
forming a tubular flowpath wall that includes a sidewall, a flange, a shell and a liner, the sidewall extending axially along an axis from an upstream end of the tubular flowpath wall to a downstream end of the tubular flowpath wall, the sidewall formed by the shell and the liner, the flange disposed at the downstream end of the tubular flowpath wall, the flange projecting radially out from the sidewall, the flange formed by at least the liner, the shell extending axially along and circumscribing the liner, and the liner at least partially forming an outer peripheral boundary of a flowpath axially along and radially within the tubular flowpath wall;
the forming of the tubular flowpath wall including
additively manufacturing the shell from a polymeric material; and
additively manufacturing the liner onto the shell from a metal material.

20. The method of claim 19, wherein at least one of
the additively manufacturing of the shell comprises building the shell using a material extrusion process; or
the additively manufacturing of the liner comprises building the liner onto the shell using a cold spray process.
